(19) United States
(12) Patent Application Publication
(10) Pub. No.: US 2024/0406544 A1
(43) Pub. Date: Dec. 5, 2024

(54) INFORMATION PROCESSING DEVICE AND PROGRAM

(71) Applicant: Sony Group Corporation, Tokyo (JP)

(72) Inventors: Toshio OHKI, Tokyo (JP); Hidenari SHINOTOU, Tokyo (JP); Itsuki YAMASHITA, Tokyo (JP)

(73) Assignee: Sony Group Corporation, Tokyo (JP)

(21) Appl. No.: 18/698,358

(22) PCT Filed: Sep. 13, 2022
(86) PCT No.: PCT/JP2022/034237

§ 371 Date: Apr. 4, 2024

(30) Foreign Application Priority Data
Oct. 15, 2021 (JP) 2021-169471

(51) Int. Cl. H04N 23/63; G06T 7/73

(52) U.S. Cl. CPC H04N 23/635; G06T 7/74; G06T 2207/30196

(57) ABSTRACT

An information processing device includes a composition position determiner that determines a composition position of an auxiliary image in a second captured image captured after a first captured image in accordance with a position and a motion of a subject in the first captured image, and a composition processing unit that composites the auxiliary image with the composition position in the second captured image.

### TECHNICAL FIELD

The present technology relates to an information processing device and a program that generate an image obtained by compositing an auxiliary image with a captured image.

### BACKGROUND ART

An imaging device is provided with a viewfinder and a monitor capable of confirming an image to be captured. There are an optical viewfinder and an electronic viewfinder. In addition, an image based on image data is displayed on the monitor.

It is known that a state of a subject displayed on an electronic viewfinder or monitor is delayed from a state of the subject in a case where the subject to be imaged is directly visually recognized.

Such a delay can also be a factor of missing an appropriate imaging timing, and is thus desirably reduced as much as possible.

Patent Document 1 below discloses a technique of shortening time until a preview image is displayed by performing processing on each of two types of data having different densities by using a low-resolution image signal and a high-resolution image signal.

### CITATION LIST

### Patent Document

Patent Document 1: WO 2015/170503

### SUMMARY OF THE INVENTION

### Problems to be Solved by the Invention

Meanwhile, there is a case where a display image in which various auxiliary images are composited with a preview image is generated and presented to a photographer. For example, the display image displayed on the viewfinder is obtained by compositing an auxiliary image as a frame image such as a face frame or a pupil frame with a preview image (so-called through image) obtained as a captured image.

At this time, the auxiliary image may be composited with the preview image at an inappropriate position. For example, in a case where the subject is a moving subject, it is considered that the position of the face of the subject is identified from the captured image, and an auxiliary image as a face frame is generated and composited. If the time required for the processing of identifying the position of the face of the subject or the processing of generating the auxiliary image becomes longer, the preview image with which the auxiliary image is composited may be an image captured several frames after the preview image used for generating the auxiliary image.

As a result, there is a possibility that the photographer misunderstands that the face of the person is not correctly recognized.

In addition, when the display of the preview image is delayed in accordance with the generation of the auxiliary image, a deviation between the subject and the frame image is eliminated, but a display delay of the image displayed on the viewfinder or the like increases, and an imaging timing is more likely to be missed.

Therefore, an object of the present technology is to eliminate a display deviation between a preview image and an auxiliary image without increasing a display delay of a display image.

### Solutions to Problems

An information processing device of the present technology includes a composition position determiner that determines a composition position of an auxiliary image in a second captured image captured after a first captured image in accordance with a position and a motion of a subject in the first captured image, and a composition processing unit that composites the auxiliary image with the composition position in the second captured image.

For example, the position of the subject in the second captured image to be captured in the future is predicted on the basis of the position of the subject in the first captured image. Then, the predicted position in the second captured image is determined as the composition position, and the auxiliary image is composited with the composition position. Accordingly, a delay of the display of the auxiliary image for the display of the captured image in which a moving subject is imaged is eliminated.

A program of the present technology is executed by an information processing device and includes a composition position determination function of determining a composition position of an auxiliary image in a second captured image captured after a first captured image in accordance with a position and a motion of a subject in the first captured image, and a composition function of compositing the auxiliary image with the composition position in the second captured image.

An information processing device of the present technology includes a first processor that performs image processing on a captured image output from a pixel array unit in which pixels each having a photoelectric conversion element are two-dimensionally arranged and processing of determining a composition position of an auxiliary image to be composited with the captured image on the basis of the captured image, and a second processor that performs processing of displaying, on a display unit, a composite image obtained by compositing the auxiliary image with the composition position in a processed image subjected to the image processing.

For example, the first processor is a calculation processing unit that mainly performs processing related to imaging, and the second processor is a calculation processing unit that performs overall control of the information processing device and processing of implementing other applications.

A program of the present technology is a program executed by an information processing device, causes a first processor to execute image processing on a captured image output from a pixel array unit and processing of determining a composition position in an auxiliary image to be composited with the captured image on the basis of the captured image, and includes processing of displaying, on a display unit, a composite image obtained by compositing the auxiliary image with the composition position of an image subjected to the image processing.

### BRIEF DESCRIPTION OF DRAWINGS

FIG. 1 is a block diagram illustrating a configuration example of an information processing device according to a first embodiment of the present technology.

FIG. 2 is a block diagram illustrating a functional configuration of a control unit of the first embodiment.

FIG. 3 is a diagram illustrating an example of a preview image.

FIG. 4 is a diagram illustrating an example of an auxiliary image.

FIG. 5 is a diagram illustrating an example of a composite image obtained by compositing an auxiliary image with a preview image together with FIG. 6, and FIG. 5 is a diagram illustrating a state in which composition positions of a subject to be tracked and a frame image coincide with each other.

FIG. 6 is a diagram illustrating a state in which composition positions of a subject to be tracked and a frame image do not coincide with each other.

FIG. 7 is a diagram illustrating a flow of processing in the first embodiment.

FIG. 8 is a flowchart illustrating the flow of processing in the first embodiment.

FIG. 9 is a block diagram illustrating a configuration example of an information processing device according to a second embodiment of the present technology.

FIG. 10 is a block diagram illustrating a functional configuration of a camera control unit according to the second embodiment.

FIG. 11 is a block diagram illustrating a functional configuration of a control unit of the second embodiment.

FIG. 12 is a diagram illustrating a flow of processing in the second embodiment.

FIG. 13 is a flowchart illustrating the flow of processing in the second embodiment.

FIG. 14 is a block diagram illustrating a configuration example of an information processing device according to a third embodiment of the present technology.

### MODE FOR CARRYING OUT THE INVENTION

Hereinafter, embodiments will be described in the following order with reference to the accompanying drawings.
1. First Embodiment
<1-1. Configuration of information processing device>
<1-2. Functional configuration of control unit><1-3. Flow of processing>
2. Second Embodiment
<2-1. Configuration of information processing device>
<2-2. Functional configuration of camera control unit and control unit>
<2-3. Flow of processing>
3. Third Embodiment
<4. Modifications>
<5. Summary>
<6. Present technology>

### 1. First Embodiment

### <1-1. Configuration of Information Processing Device>

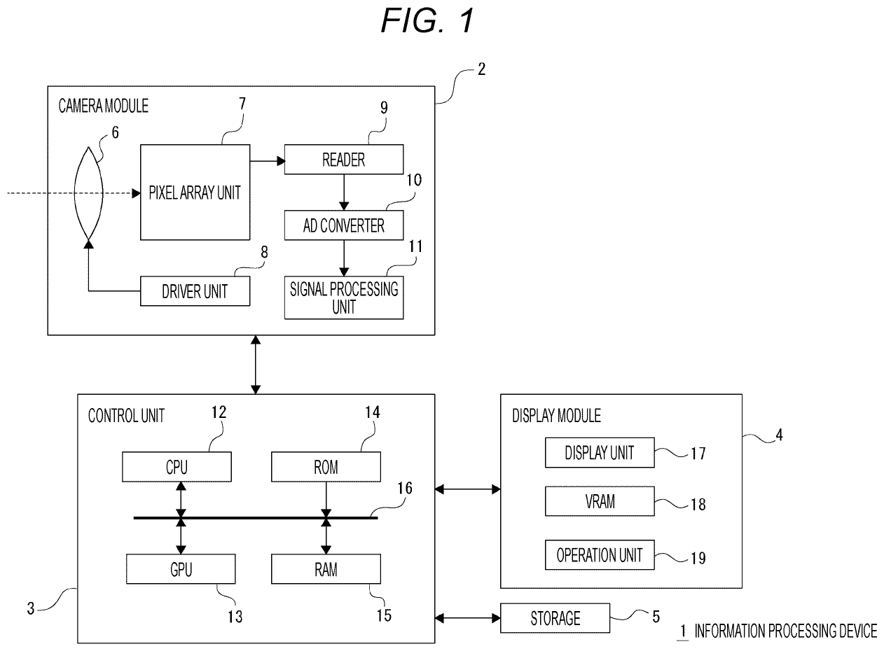

A configuration of an information processing device 1 according to a first embodiment will be described with reference to FIG. 1.

Note that the information processing device 1 is an information processing device having a camera function, and in the following description, a smartphone will be described as an example.

The information processing device 1 as a smartphone includes a camera module 2, a control unit 3, a display module 4, and a storage 5.

The camera module 2 includes an optical system 6, a pixel array unit 7, a driver unit 8, a reader 9, an analog to digital (AD) converter 10, and a signal processing unit 11.

The optical system 6 includes optical components such as various lenses and a diaphragm mechanism for condensing incident light on the pixel array unit 7. The optical system 6 may include a mechanical shutter mechanism.

The pixel array unit 7 is provided in, for example, a charge coupled device (CCD) image sensor or a complementary metal-oxide semiconductor (CMOS) image sensor, and pixels including photoelectric conversion elements are two-dimensionally arranged.

Each of the pixels has a configuration in which, for example, a microlens, a light receiving element, a filter, and the like are stacked, and outputs an electric signal obtained by photoelectrically converting received light by the light receiving element.

The driver unit 8 includes motor drivers or the like that drive various lenses and a diaphragm mechanism on the basis of a control signal output from the control unit 3. Each of the motor drivers supplies a drive current to a corresponding drive motor according to an instruction from the control unit 3.

The reader 9 reads charges accumulated in each of the pixels of the pixel array unit 7 in accordance with various timing signals. This reading processing is performed, for example, for every row sequentially selected in the pixel array unit 7.

The AD converter 10 performs AD conversion processing of converting the charge (pixel signal of analog data) read by the reader 9 into a digital value.

The signal processing unit 11 performs various types of processing on the pixel signal as digital data output from the AD converter 10 to generate image data.

Specifically, the signal processing unit 11 performs pre-processing and post-processing.

The pre-processing can include, for example, pixel rearrangement processing based on various correction processing, brightness adjustment processing, white balance adjustment processing, high dynamic range (HDR) processing, noise reduction processing, and the like.

The post-processing can include, for example, color correction processing.

Furthermore, the signal processing unit 11 performs resolution conversion processing of converting a high-resolution image into a low-resolution image. For example, the signal processing unit 11 performs processing of converting an image having a resolution corresponding to the number of pixels of a 2K image of about 1920 pixels in height and 1080 pixels in width, a 4K image of about 4096 pixels in height and 2160 pixels in width or 3840 pixels in height and 2160 pixels in width, or an 8K image of about 7680 pixels in height and 4320 pixels in width into an image having a lower resolution.

In the following description, digital data input from the AD converter 10 to the signal processing unit 11 will be referred to as “captured image data”. In addition, a high-resolution image subjected to pre-processing and post-processing in the signal processing unit 11 will be referred to as a “processed image”. Then, a low-resolution image converted from the processed image is described as a “preview image PP”.

The control unit 3 performs overall control of the information processing device 1 as a smartphone. In addition, still image data and moving image data stored in the storage 5 are generated by performing further processing on the processed image generated by the signal processing unit 11.

Furthermore, the control unit 3 generates a composite image obtained by compositing an auxiliary image SP described later with the preview image PP.

The control unit 3 includes a central processing unit (CPU) 12, a graphics processing unit (GPU) 13, a read only memory (ROM) 14, and a random access memory (RAM) 15.

The CPU 12, the GPU 13, the ROM 14, and the RAM 15 are mutually connected by a bus 16.

The CPU 12 executes processing related to various applications executed by the information processing device as a smartphone. That is, the CPU 12 executes processing of implementing not only a function implemented by using the camera module 2 but also a function unrelated to the camera module 2, such as an e-mail or a telephone, for example.

The GPU 13 is a calculation processing unit that executes processing related to an image, and performs processing of displaying a still image or a moving image on the display module 4, for example.

The ROM 14 and the RAM 15 store a program and the like used by the control unit 3. The ROM 14 and the RAM 15 store an operating system (OS) for the CPU 12 and the GPU 13 to control each unit, content files such as an image file, and an application program, firmware, and the like for various operations.

Note that the ROM 14 and the RAM 15 used by the CPU 12 and the ROM 14 and the RAM 15 used by the GPU 13 may be provided in the control unit 3.

The functional configuration of the control unit 3 implemented by the CPU 12 and the GPU 13 will be described later again.

The display module 4 performs processing of displaying an image such as a still image or a moving image on the basis of a control signal from the control unit 3. An image displayed by the display module 4 to a photographer is referred to as a “display image”. The display image includes not only a composite image but also a still image and a moving image captured and stored by the photographer.

The display module 4 includes a display unit 17, a video RAM (VRAM) 18, and an operation unit 19.

The display unit 17 is, for example, a display device such as a liquid crystal display (LCD) or an organic electro-luminescence (EL) display.

Note that the display unit 17 may be provided as an electric viewfinder (EVF) or the like.

The VRAM 18 is a storage in which data of the display image displayed on the display unit 17 is temporarily stored.

The display device provided as the display unit 17 functions as the operation unit 19 by mounting a touch panel function.

### <1-2. Functional Configuration of Control Unit>

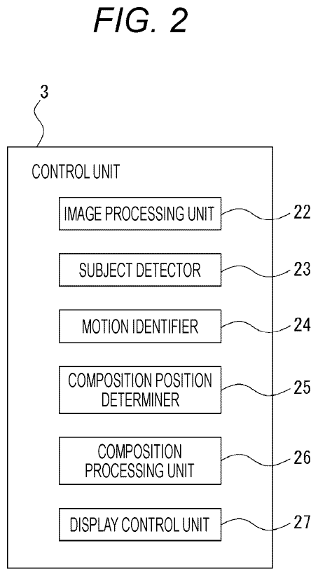

FIG. 2 illustrates an example of the functional configuration of the control unit 3.

The control unit 3 includes an image processing unit 22, a subject detector 23, a motion identifier 24, a composition position determiner 25, a composition processing unit 26, and a display control unit 27.

The image processing unit 22 performs processing of converting a high-resolution processed image into image data in a predetermined file format and storing the image data in the storage 5.

In addition, the image processing unit 22 performs processing of converting the preview image PP output from the signal processing unit 11 into an image signal in a format displayable by the display unit 17 of the display module 4. Note that this processing may be executed by the display control unit 27.

The subject detector 23 performs image recognition processing on the preview image PP to detect a subject to be tracked. The subject to be detected may be set in advance by the photographer.

For example, in a case where a pupil of the subject is the subject to be tracked, the subject detector 23 performs the image recognition processing on the preview image PP, detects a person as the subject, identifies a face region of the person, and further identifies a region estimated as the pupil in the face region.

The identification is performed by using, for example, coordinates in the preview image PP.

Note that the image recognition processing by the subject detector 23 may be performed by using an artificial intelligence (AI) model.

The motion identifier 24 calculates a moving direction and a moving amount of the subject to be tracked.

The motion of the subject to be tracked is identified by the motion identifier 24 by using a plurality of preview images PP. For example, a transition of the position of the subject in the plurality of preview images PP sequentially captured is identified, and in a case where the subject gradually moves from the left to the right, it is identified that the subject moves from the left to the right. Then, the moving amount can also be calculated in accordance with a change in the coordinates of the subject in the plurality of preview images PP.

Note that the motion of the subject identified here is a motion within an angle of view. Therefore, for example, even in a case where the subject moves from the right to the left in a real space, in a case where the angle of view is panned from the right to the left, the motion of the subject may be identified as moving from the left to the right.

Note that each processing of the subject detector 23 and the motion identifier 24 may be performed on a high-resolution processed image.

The composition position determiner 25 determines a superimposed position of the auxiliary image SP as a composition position on the basis of the motion (moving direction and moving speed) of the subject identified by the motion identifier 24.

As will be described specifically later, in the present embodiment, in a case where a subject to be tracked is detected, the auxiliary image SP for indicating the position of the detected subject is composited.

The auxiliary image SP is, for example, a frame image indicating the position of a pupil of the person who is the subject to be tracked.

The auxiliary image SP is composited with the preview image PP and generated as a composite image.

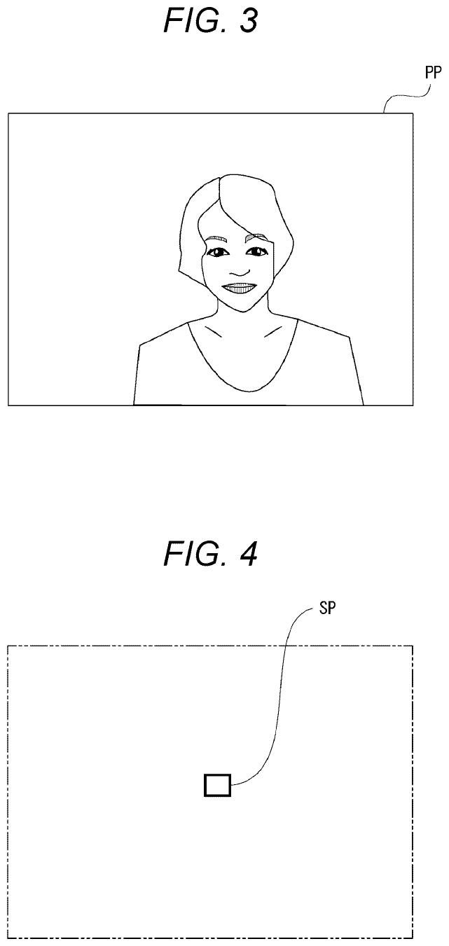

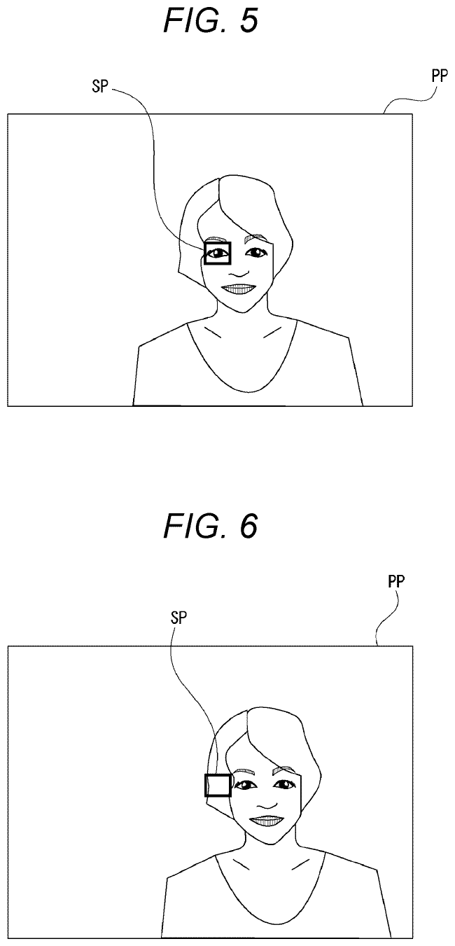

FIG. 3 illustrates an example of the preview image PP, and FIG. 4 illustrates an example of the auxiliary image SP. Furthermore, FIG. 5 illustrates a composite image obtained by compositing the auxiliary image SP with the preview image PP.

Here, the preview image PP used for detecting the subject to be tracked and the preview image PP in which the auxiliary image SP for indicating the subject to be tracked are composited are captured at different timings.

Therefore, for example, in a case where the subject to be tracked is a moving subject, if the auxiliary image SP indicating the position of the pupil detected in the preview image is composited with the original position in the preview image PP several frames later, the position of the pupil in the preview image PP and the position of the auxiliary image SP are deviated from each other as illustrated in FIG. 6.

The composition position determiner 25 estimates the position of the pupil several frames later in accordance with the motion of the position of the pupil identified by the motion identifier 24. Then, the estimated position of the pupil is determined as the composition position.

As a result, a discrepancy between the position of the subject and the position of the auxiliary image SP can be eliminated.

Note that, in the description of this example, the composition position is determined on the basis of the predicted position of the subject two frames later in view of compositing the auxiliary image SP with the preview image PP two frames later.

However, depending on the time required for the processing of each processing by the control unit 3, the auxiliary image SP may be composited with the preview image PP one frame later, or the auxiliary image SP may be composited with the preview image PP captured three or more frames later.

FIG. 2 will be described again.

The composition processing unit 26 composites the auxiliary image SP with the preview image PP to generate a composite image as illustrated in FIG. 5.

Note that the composition processing unit 26 may further generate, as the composite image, an image on which an icon image for flash setting, a button for switching between a still image and a moving image, an image indicating time information, battery information, or the like is further superimposed.

The display control unit 27 outputs the composite image generated by the composition processing unit 26 to the display module 4 at a predetermined timing. As a result, a display image based on the composite image is displayed on the display unit 17.

A relationship between each processing and an image is briefly summarized.

An image data converted into digital data by the AD converter 10 is captured image data (high-resolution image data). The signal processing unit 11 performs pre-processing and post-processing on the captured image data to generate a processed image.

Furthermore, the signal processing unit 11 performs resolution conversion processing on the processed image to generate a low-resolution preview image PP.

Then, a composite image is generated by compositing the auxiliary image SP with the preview image PP. An image displayed on the display unit 17 on the basis of the composite image is a display image.

Note that the signal processing unit 11 may include some of the units included in the control unit 3. For example, the processing of the subject detector 23 may be executed by the signal processing unit 11.

### <1-3. Flow of Processing>

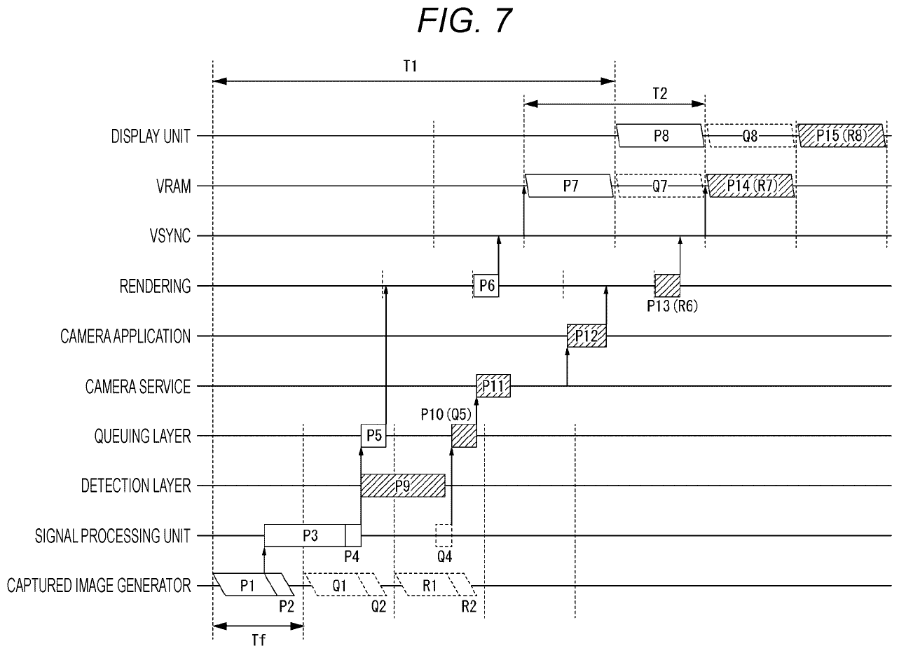

The flow of processing of each unit from an imaging operation to the display of an image on the display unit 17 will be described with reference to FIG. 7.

First, a captured image generator performs an exposure operation P1 and read processing P2. Here, the captured image generator includes the pixel array unit 7, the reader 9, and the AD converter 10 in the camera module 2. That is, the read processing P2 is a combination of the charge reading by the reader 9 and the AD conversion processing by the AD converter 10.

Note that the vertical axis of the broken line illustrated in the drawing indicates a reference timing in units of frames. Therefore, the exposure operation and the read processing by the captured image generator are repeatedly executed at every timing defined by a predetermined frame time Tf. Then, the exposure operation started at a first timing illustrated in FIG. 7 is referred to as the exposure operation P1, and the read processing is referred to as the read processing P2.

Then, the exposure operation started at the reference timing immediately after the read processing P2 is set as an exposure operation Q1, and the subsequent read processing is set as read processing Q2.

Furthermore, the exposure operation started at the reference timing immediately after the read processing Q2 is set as an exposure operation R1, and the subsequent read processing is set as read processing R2.

In each of the following processing, processing related to a signal or an image generated on the basis of the exposure operation P1 will be described with reference sign “P”, processing related to a signal or an image generated on the basis of the exposure operation Q1 will be described with reference sign “Q”, and processing related to a signal or an image generated on the basis of the exposure operation R1 will be described with reference sign “R”.

The signal processing unit 11 sequentially executes pre-processing P3 on high-resolution digital data read by the read processing P2 after completion of the exposure operation P1, and subsequently executes post-processing P4. Furthermore, the signal processing unit 11 generates a low-resolution preview image PP by performing the resolution conversion processing.

The preview image PP subjected to the post-processing P4 and converted to low resolution is added to a queue by enqueue processing P5 by a queuing layer and then delivered to a rendering layer. In the rendering layer, rendering processing P6 of generating display data from the preview image PP retrieved by dequeue processing is executed.

At this time, depending on an execution timing of the enqueue processing P5, a standby time until a start of the rendering processing P6 occurs.

The display data is stored in the VRAM 18 by temporary storage processing P7 executed at a timing synchronized with a vertical synchronization (VSYNC) signal.

In the display (display unit 17), display processing P8 of displaying the display data stored in the VRAM 18 is performed in accordance with the reference timing for every frame in the display module 4.

Note that a time difference from a start of the exposure operation P1 to a start of the display processing P8 is a time required from imaging to display of the preview image PP, and is set as display delay time T1.

Here, in parallel with each of the processing P5 to P8, processing of generating and compositing the auxiliary image SP based on the exposure operation P1 is executed. FIG. 7 illustrates these processing with hatching.

Specifically, by using the preview image PP, in a detection layer, processing of implementing the function as the subject detector 23 is performed as detection processing P9. That is, the detection processing P9 includes processing of performing image recognition processing on the preview image PP to detect a subject to be detected.

Subsequently, enqueue processing P10 of adding information regarding a detection position of the subject, that is, a composition position of the auxiliary image SP, to the queue is executed in the queuing layer. In the enqueue processing P10, processing of adding the low-resolution preview image PP based on the processed image obtained by the post-processing Q4 performed as processing subsequent to the exposure operation Q1 to the queue is also performed. That is, the enqueue processing P10 also functions as enqueue processing Q5.

A camera service function performs dequeue processing of extracting information of the composition position added to the queue by the enqueue processing P10, and executes processing of implementing the functions of the motion identifier 24 and the composition position determiner 25 as drawing position identification processing P11. That is, the drawing position identification processing P11 includes processing of identifying the motion of the subject, calculating the predicted position of the subject, and determining the composition position of the auxiliary image SP.

A camera application performs generation processing P12 of generating the auxiliary image SP in accordance with the determined composition position. The generated auxiliary image SP is delivered to the rendering layer.

In the rendering layer, rendering processing P13 of the auxiliary image SP extracted by the dequeue processing is executed.

In the example illustrated in FIG. 7, since the enqueue processing of the auxiliary image SP based on the exposure operation P1 has not been in time at the time of the rendering processing of the preview image PP based on the exposure operation Q1, rendering of the auxiliary image SP is performed in accordance with rendering processing R6 of the preview image PP based on the exposure operation R1. By the rendering processing P13 (R6), display data in which the auxiliary image SP is composited with the preview image PP is generated.

The display data is stored in the VRAM 18 by temporary storage processing P14 executed at a timing synchronized with a VSYNC signal. The temporary storage processing P14 is also processing related to the preview image PP based on the exposure operation R1, and thus, also functions as temporary storage processing R7.

In the display, display processing P15 of displaying the display data stored in the VRAM 18 is performed in accordance with the reference timing for every frame in the display module 4. The display processing P15 is also processing related to the preview image PP based on the exposure operation R1, and thus, also functions as display processing R8.

That is, the display of the auxiliary image SP is delayed by two frames from the display of the preview image PP. This delay time is referred to as an auxiliary image delay time T2. The processing of identifying the motion of the subject and the processing of calculating the predicted position of the subject executed as the drawing position identification processing P11 described above are executed in order to eliminate a positional deviation between the subject to be tracked and the auxiliary image SP in the preview image PP by the delay time.

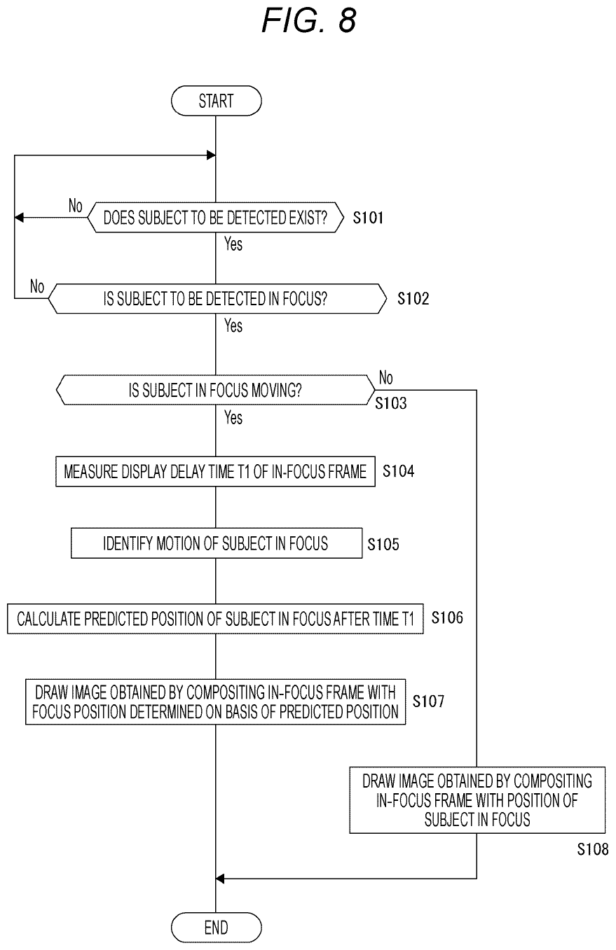

These processing will be described with reference to a flowchart illustrated in FIG. 8. The series of processing illustrated in FIG. 8 is repeatedly executed, for example, every frame time Tf.

Note that each processing illustrated in FIG. 8 is processing of superimposing an in-focus frame indicating that a specific subject is focused.

In step S101, the CPU 12 of the control unit 3 determines whether or not a subject (for example, a pupil) to be detected exists within the angle of view of the image. In a case where the subject to be detected does not exist within the angle of view, the processing of step S101 is executed again.

In a case where it is determined that the subject to be detected exists within the angle of view, the CPU 12 of the control unit 3 determines whether or not the subject to be detected is in focus in step S102.

This determination processing is performed on the basis of a defocus amount calculated for every subject to be detected. That is, a subject having the smallest defocus amount and less than a threshold is identified as a subject in focus. Therefore, in a case where there is no subject having a defocus amount less than the threshold, it is determined that the subject to be detected is not in focus. Note that focus control is performed independently of each processing illustrated in FIG. 8.

In a case where it is determined that the subject to be detected is in focus, the CPU 12 of the control unit 3 determines whether or not the subject in focus is moving in step S103. This processing is performed by using the plurality of preview images PP as described above. By this processing, the display delay time T1 is calculated.

In a case where it is determined that the subject is moving, the CPU 12 of the control unit 3 measures the display delay time T1 of the in-focus frame in step S104. That is, a temporal difference between a timing at which the preview image PP used to generate the auxiliary image SP as the in-focus frame is displayed and a timing at which the composite image compositing the auxiliary image SP is displayed is measured as the auxiliary image delay time T2.

For example, the auxiliary image SP can be provided with a frame identification (ID), a time stamp, and the like used for generating the auxiliary image SP as accompanying data.

In step S105, the CPU 12 of the control unit 3 identifies the motion (moving direction and moving amount) of the subject in focus. Note that the processing of step S105 may be performed before the processing of step S104.

In step S106, the CPU 12 of the control unit 3 calculates a predicted position of the subject in focus after the time T1.

In step S107, the CPU 12 of the control unit 3 performs processing of displaying, on the display unit 17, a composite image obtained by compositing the in-focus frame with a focus position determined on the basis of the predicted position.

As a result, the in-focus frame in a state in which the deviation from the moving subject is eliminated is superimposed on the subject and displayed.

On the other hand, in a case where it is determined in step S103 that the subject in focus is not moving, the CPU 12 of the control unit 3 performs processing of displaying a composite image obtained by compositing the in-focus frame with the position of the subject in focus in step S108. That is, the processing of calculating the predicted position of the subject and the like are not performed.

### 2. Second Embodiment

### <2-1. Configuration of Information Processing Device>

An information processing device 1A according to a second embodiment includes a dedicated calculation processing unit for implementing a camera function.

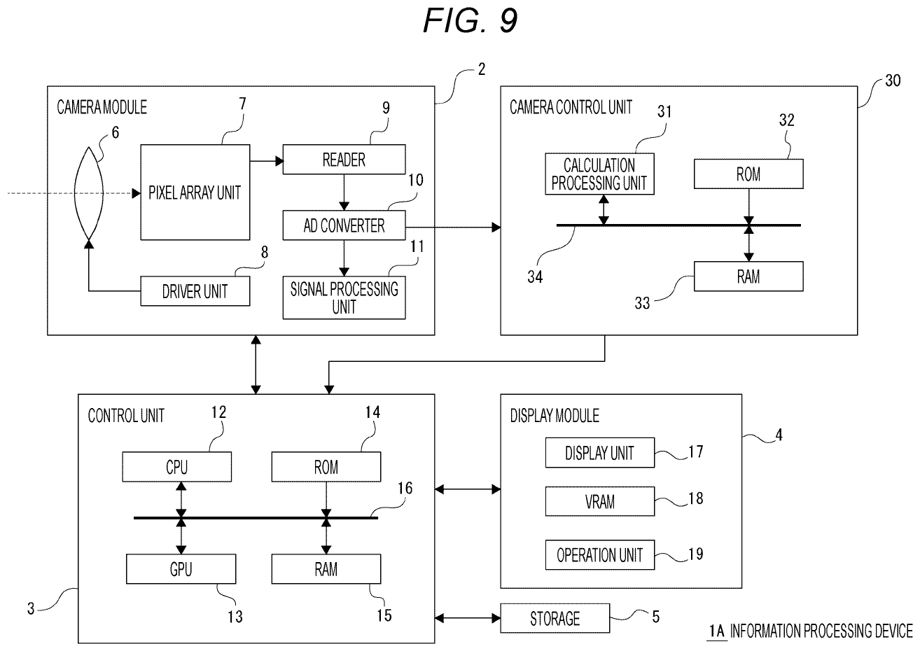

FIG. 9 illustrates a configuration example of the information processing device 1A according to the second embodiment.

The information processing device 1A includes a camera control unit 30 in addition to the camera module 2, the control unit 3, the display module 4, and the storage 5.

Note that configurations similar to those of the first embodiment are denoted by the same reference signs as in FIG. 2, and description thereof will be omitted as appropriate.

The AD converter 10 of the camera module 2 performs AD conversion processing of converting the charge read by the reader 9 into a digital value.

The pixel signal converted into a digital value by the AD converter 10 is not only output to the signal processing unit 11 but also output to the camera control unit 30.

The signal processing unit 11 of the camera module 2 executes pre-processing and post-processing on the high-resolution captured image data. Note that a part of each processing executed as the pre-processing or post-processing may be executed by the CPU 12 of the control unit 3.

On the other hand, the camera control unit 30 performs processing of displaying the preview image PP on the display unit 17 on the basis of captured image data output from the AD converter 10.

Specifically, the camera control unit 30 generates a low-resolution image for generating the preview image PP by performing resolution conversion processing on the captured image data output from the AD converter 10. This image is an image that has not been subjected to the pre-processing or post-processing, and is described as a “low-resolution image”.

Furthermore, the camera control unit 30 generates the preview image PP by executing the pre-processing and the post-processing on the low-resolution image, performs processing of detecting a subject to be tracked from the low-resolution image and processing of generating the auxiliary image SP, and performs processing of generating a composite image by compositing the auxiliary image SP with the preview image PP.

In the camera control unit 30, the processing of generating the preview image PP and the processing of generating the auxiliary image SP are performed in parallel. That is, the camera control unit 30 ends the processing of determining the composition position of the auxiliary image SP and the processing of generating the auxiliary image SP before ending the pre-processing and post-processing of generating the preview image PP.

As a result, the captured image data that is a generation source of the auxiliary image SP and the captured image data that is a generation source of the preview image PP are the same. Therefore, a display position is not deviated due to a difference in imaging timing as described in the first embodiment.

The composite image generated by the camera control unit 30 is output to the control unit 3.

The control unit 3 outputs the input composite image to the display module 4 at a predetermined timing.

Note that a part of the processing of generating a composite image, for example, processing of compositing images for presenting information regarding imaging setting, and processing of further compositing various icon images such as buttons, images indicating time information, battery information, and the like may be executed by the control unit 3 instead of the camera control unit 30. In other words, the control unit 3 may execute processing of compositing images other than the frame image for indicating a tracking target.

The camera control unit 30 includes a calculation processing unit 31, a ROM 32, and a RAM 33. The calculation processing unit 31, the ROM 32, and the RAM 33 are communicably connected to each other by a bus 34.

The calculation processing unit 31 includes a CPU, a GPU, and the like, and performs various types of processing for generating a composite image and transmitting the composite image to the control unit 3.

The ROM 32 and the RAM 33 store a program and the like used by the calculation processing unit 31. The ROM 32 and the RAM 33 store an operating system (OS), an application program, firmware, and the like for the CPU and the GPU as the calculation processing unit 31 to perform predetermined processing.

<2-2. Functional Configuration of Camera Control unit and control unit>

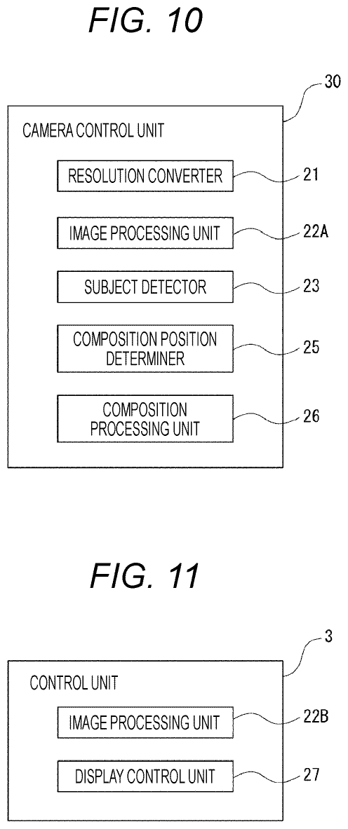

FIG. 10 illustrates an example of a functional configuration of the camera control unit 30, and FIG. 11 illustrates an example of a functional configuration of the control unit 3.

Note that a description of each function overlapping with the function described in FIG. 2 will be appropriately omitted.

The camera control unit 30 includes a resolution converter 21, an image processing unit 22A, the subject detector 23, the composition position determiner 25, and the composition processing unit 26.

The resolution converter 21 performs resolution conversion processing on a high-resolution image to generate a low-resolution image.

The image processing unit 22A performs processing of converting the low-resolution image generated by the resolution converter 21 into an image signal in a format displayable by the display unit 17 of the display module 4.

Note that, unlike the first embodiment, in the second embodiment, the captured image input to the camera control unit 30 is an image before the pre-processing and the post-processing are performed.

Therefore, the image processing unit 22A generates the preview image PP by performing the pre-processing and the post-processing on the low-resolution image.

Note that, the pre-processing and the post-processing executed by the image processing unit 22A are processing for a low-resolution image, and thus, have a greatly reduced amount of calculation as compared with the pre-processing and the post-processing executed in the first embodiment. Therefore, time required for the pre-processing and the post-processing is also shorter.

The subject detector 23 performs image recognition processing on the low-resolution image to detect a subject to be tracked.

The composition position determiner 25 determines the position of the subject detected by the subject detector 23 as the composition position of the auxiliary image SP.

The auxiliary image SP is, for example, a frame image indicating a specific position of the person who is the subject to be tracked.

The composition processing unit 26 composites the auxiliary image SP with the preview image PP to generate a composite image as illustrated in FIG. 5.

The control unit 3 includes an image processing unit 22B and the display control unit 27.

The image processing unit 22B executes a part of image processing not required to be executed in a real-time manner, instead of the image processing unit 22A of the camera control unit 30.

The display control unit 27 outputs a final composite image generated by the image processing unit 22B to the display module 4 at a predetermined timing. As a result, the preview image PP is displayed on the display unit 17.

### <2-3. Flow of Processing>

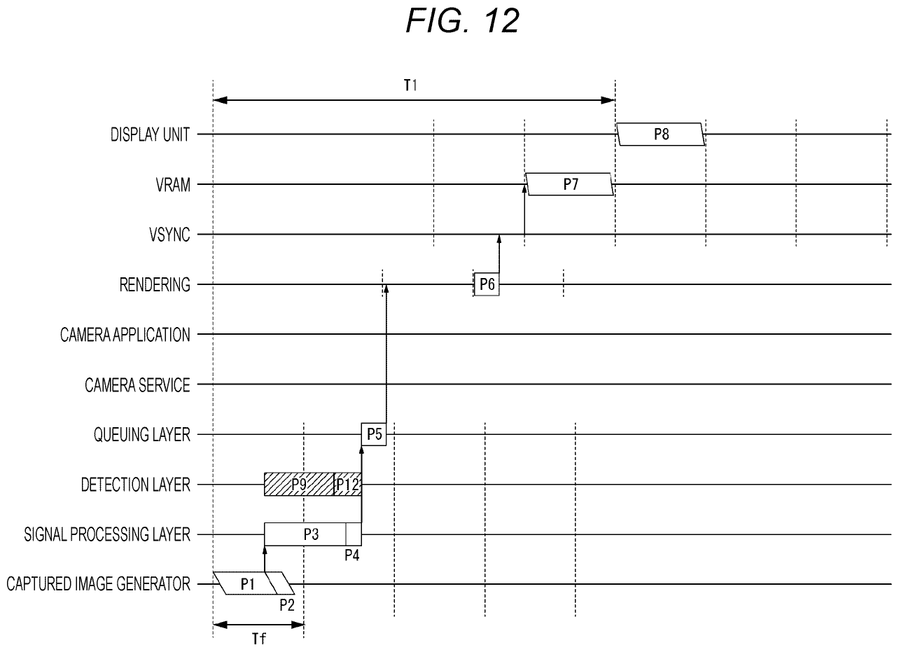

The flow of processing from an imaging operation in the second embodiment to the display of an image on the display unit 17 will be described with reference to FIG. 12.

Note that description of processing similar to processing in FIG. 7 will be omitted as appropriate.

First, a captured image generator performs an exposure operation P1 and read processing P2. Here, the captured image generator includes the pixel array unit 7, the reader 9, and the AD converter 10 in the camera module 2. That is, the read processing P2 is a combination of the charge reading by the reader 9 and the AD conversion processing by the AD converter 10.

The digital data read by the read processing P2 is output to each of a signal processing layer and a detection layer. Then, the processing as the image processing unit 22A in the signal processing layer and the processing as the resolution converter 21, the subject detector 23, and the composition position determiner 25 in the detection layer are executed in parallel.

Specifically, in the signal processing layer, pre-processing P3 is sequentially executed on the high-resolution digital data read by the read processing P2 after completion of the exposure operation P1, and then post-processing P4 is executed on the high-resolution digital data. Furthermore, the signal processing unit 11 generates a low-resolution preview image PP by performing the resolution conversion processing. Note that the pre-processing and the post-processing may be executed after the resolution conversion processing is performed.

The preview image PP generated in the post-processing P4 is added to the queue by the enqueue processing P5 by the queuing layer.

In addition, in parallel with the above, in the detection layer, processing of implementing the functions of the resolution converter 21, the subject detector 23, and the composition position determiner 25 is performed as the detection processing P9. That is, the detection processing P9 includes processing of generating a low-resolution image by resolution conversion and detecting a subject to be detected by performing image recognition on the low-resolution image, and processing of determining a composition position of the auxiliary image SP.

Furthermore, although the resolution conversion is performed in the detection processing P9 in the present embodiment, what is subjected to the resolution conversion in the pre-processing P3 may be bypassed to the detection processing P9 and subjected to the image recognition.

In addition, in the detection layer, the generation processing P12 of generating the auxiliary image SP is performed. The generated auxiliary image SP is added to the queue in the previous enqueue processing P5.

Note that, in the generation processing P12, processing of generating a composite image obtained by compositing the auxiliary image SP with the preview image PP may be performed. In this case, in the enqueue processing P5, the composite image is added to the queue.

The data added to the queue is delivered to the rendering layer at a predetermined timing. In the rendering layer, the rendering processing P6 of generating display data by using the preview image PP and the auxiliary image SP retrieved by the dequeue processing or using the composite image is executed.

The display data is stored in the VRAM 18 by the temporary storage processing P7 executed at a timing synchronized with a VSYNC signal.

In the display (display unit 17), display processing P8 of displaying the display data stored in the VRAM 18 is performed in accordance with the reference timing for every frame in the display module 4.

As a result, an image in which the auxiliary image SP is superimposed on the preview image PP is displayed on the display unit 17.

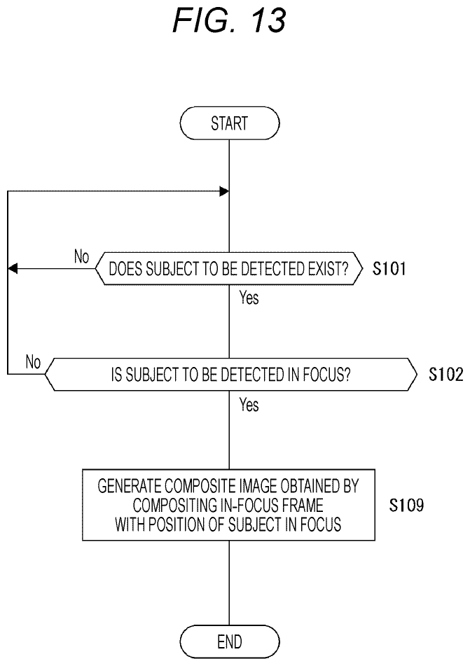

Next, the flow of processing executed by the camera control unit 30 will be described with reference to a flowchart illustrated in FIG. 13.

Note that, similarly to FIG. 8, each processing illustrated in FIG. 13 is processing of superimposing an in-focus frame indicating that a specific subject is focused.

In step S101, the calculation processing unit 31 of the camera control unit 30 determines whether or not a subject (for example, a pupil) to be detected exists within the angle of view. In a case where the subject to be detected does not exist within the angle of view, the processing of step S101 is executed again.

In a case where it is determined that the subject to be detected exists within the angle of view, the calculation processing unit 31 of the camera control unit 30 determines whether or not the subject to be detected is in focus in step S102.

In a case where it is determined that the subject to be detected is in focus, the calculation processing unit 31 of the camera control unit 30 performs processing of generating a composite image obtained by compositing the in-focus frame with the position of the subject in focus in step S109. That is, the processing of calculating the predicted position of the subject and the like are not performed.

The series of processing illustrated in FIG. 13 is repeatedly executed, for example, every frame time Tf, and thus, the in-focus frame can be displayed so as to follow the subject.

### 3. Third Embodiment

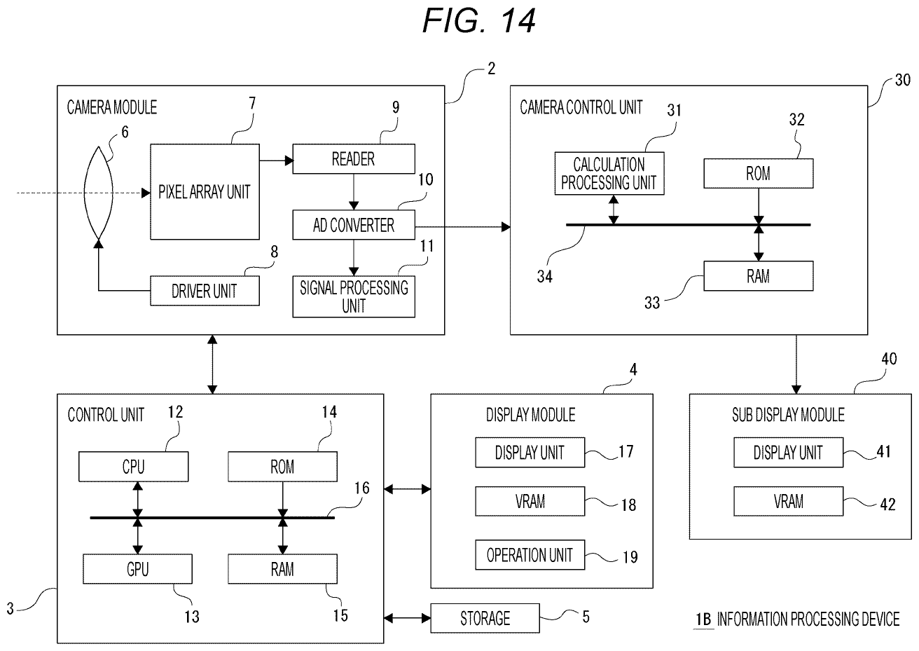

FIG. 14 illustrates a configuration example of an information processing device 1B according to a third embodiment.

The information processing device 1B further includes a sub display module 40 in addition to the display module 4.

The information processing device 1B includes the sub display module 40 in addition to the camera module 2, the control unit 3, the display module 4, the storage 5, and the camera control unit 30.

The sub display module 40 includes, for example, a display unit 41 that functions as an EVF mounted on a camera device, and a VRAM 42 that temporarily stores display data to be displayed on the display unit 41.

Furthermore, the camera control unit 30 according to the third embodiment performs processing of generating a composite image and processing of outputting the composite image to the sub display module 40 at a predetermined timing.

Specifically, the camera control unit 30 performs resolution conversion processing on the pixel signal output from the AD converter 10 to generate a low-resolution image for generating the preview image PP.

In addition, the camera control unit 30 generates the preview image PP by executing the pre-processing and post-processing on the low-resolution image, performs processing of detecting a subject to be tracked from the low-resolution image and processing of generating the auxiliary image SP, and performs processing of generating a composite image by compositing the auxiliary image SP with the preview image PP.

Furthermore, the camera control unit 30 may generate a composite image obtained by compositing images for presenting information such as various icon images and imaging conditions to be visually recognized by the photographer.

Then, the camera control unit 30 performs processing of outputting the composite image to the sub display module 40 at a predetermined timing.

That is, the control unit 3 according to the third embodiment does not perform any processing of displaying the preview image PP.

As a result, it is possible to prevent an increase in delay of image display on the sub display module 40 due to processing other than the camera function executed in the control unit 3. In other words, the low-delay preview image PP can be displayed on the display unit 41 of the sub display module 40.

Note that since the control unit 3 does not need to execute various types of processing related to the display on the display unit 41, it is possible to reduce power consumption in the control unit 3 by causing the control unit 3 to transition to a sleep mode or the like.

Furthermore, a physical operator such as a shutter button connected to the camera control unit 30 may be provided in the information processing device 1B.

For example, by configuring a signal from a shutter button to be input to the camera control unit 30, it is possible to prevent a shutter opportunity from being missed due to a processing delay caused by an increase in a control load of the control unit 3.

In addition, the sub display module 40 may function as an operation unit by mounting a touch panel function.

Note that, instead of displaying the low-delay preview image PP on the display unit 41 of the sub display module 40, the preview image PP may be displayed on the display unit 17 of the display module 4. In addition, in that case, it may be possible to select which one of the display unit 41 or the display unit 17 is to display the preview image PP by switching a mode or the like.

Furthermore, while the low-delay preview image PP is displayed on the display unit 41 of the sub display module 40, the preview image PP may also be displayed on the display unit 17 of the display module 4.

### 4. Modifications

In each example described above, an example has been described in which the auxiliary image SP is used as the in-focus frame, but the form of the auxiliary image SP is not limited to this example.

For example, the auxiliary image SP may be a face frame image for tracking the face of a person, a pupil frame image for tracking a pupil of the person, or a frame image for tracking another part of the person.

Furthermore, the auxiliary image SP may be a frame image for tracking an automobile, a bicycle, or the like, or may be a frame image for tracking a suspicious person whose behavior is suspicious. In addition, as for sports, the auxiliary image SP may be a frame image or the like for tracking a ball used in a ball game.

That is, the auxiliary image SP may include a frame image for all the subjects that can move.

### 5. Summary

As described in the first embodiment, the information processing device 1 (1A, 1B) such as a smartphone includes the composition position determiner 25 that determines the composition position of the auxiliary image SP in a second captured image (for example, an image obtained on the basis of the exposure operation R1 in FIG. 7) captured after a first captured image (for example, an image obtained on the basis of the exposure operation P1 in FIG. 7) in accordance with the position and motion of the subject (for example, a pupil of the person) in the first captured image, the information processing device 1 (1A, 1B) including the composition processing unit 26 that composites the auxiliary image SP with the composition position in the second captured image.

The position of the subject in the second captured image to be captured in the future is predicted on the basis of the position of the subject in the first captured image. Then, the predicted position in the second captured image is determined as the composition position, and the auxiliary image SP is composited with the composition position. Accordingly, the delay of the display of the auxiliary image SP for the display of the captured image in which the moving subject is imaged is eliminated.

As a result, for example, a user can accurately confirm the subject on which the auxiliary image SP is superimposed. For example, it is possible to reduce a display deviation of the in-focus frame from the subject to be focused, and to eliminate strangeness. Then, the user can identify the subject to be focused without a mistake, and can perform an accurate and quick imaging operation.

As described with reference to FIG. 7 and the like, the composition position determiner 25 may determine the position of the subject on the second captured image as the composition position on the basis of the position of the subject in the first captured image (for example, the image obtained on the basis of the exposure operation P1 in FIG. 7) and a difference in imaging timing between the first captured image and the second captured image (for example, the image obtained on the basis of the exposure operation R1 in FIG. 7).

By considering the difference in imaging timing, an appropriate composition position on the second captured image can be identified more accurately.

Therefore, the discrepancy between the position of the subject on which the auxiliary image SP is superimposed and the position of the auxiliary image SP can be further reduced, and operability can be improved.

As described above, the motion of the subject (for example, the pupil of the person) may be identified by using the captured image captured before the first captured image (for example, the image obtained on the basis of the exposure operation P1 in FIG. 7).

For example, by predicting the motion of the subject from an imaging position of the subject in a plurality of captured images including the first captured image and the previously captured image, the position of the subject in the second captured image can be confirmed more accurately.

Therefore, the operability at the time of imaging operation can be improved, and the user can be provided with high-quality experience.

As described with reference to FIGS. 4, 5, and the like, the auxiliary image SP may be a frame image indicating a specific position (for example, a pupil) of the subject (for example, a person).

For example, in a case where the subject is a person, the auxiliary image SP is a face frame in face detection, a pupil frame in pupil detection, or the like.

As a result, the display position of the frame image as the auxiliary image SP can be prevented from deviating from the face or pupil of the subject. Therefore, the user can appropriately confirm a recognition result in the image processing.

As described above, the frame image may be an image indicating the focus position.

For example, the auxiliary image SP is an in-focus frame indicating a focus region.

As a result, a display deviation between the focus region and the in-focus frame in the captured image is eliminated. Therefore, the user can release the shutter without missing an optimum imaging timing by appropriately confirming the focus region.

As described above, the auxiliary image SP may be an image indicating the position of a specific subject (for example, a pupil of a person) recognized as a result of image recognition processing on the first captured image (for example, an image obtained on the basis of the exposure operation P1 in FIG. 7).

For example, in image recognition processing for detecting a vehicle in a captured image, a frame image as the auxiliary image SP is composited and displayed so as to surround the vehicle.

Therefore, since the frame image and the like indicating a processing result of the image recognition can be superimposed on the subject to be recognized at an appropriate position, the user can appropriately confirm the result of the image recognition processing.

As described with reference to FIG. 1 and the like, the smartphone may include an imaging unit (the camera module 2) that captures the first captured image (for example, the image obtained on the basis of the exposure operation P1 in FIG. 7) and the second captured image (for example, the image obtained on the basis of the exposure operation R1 in FIG. 7).

In a relatively small terminal device including an imaging unit such as a smartphone, there is a high possibility that a display position of a subject in a captured image and a display position of the auxiliary image SP such as a frame image displayed in association with the subject are not in an appropriate positional relationship and deviate due to hardware limitations such as processing capability.

Even in such a terminal device, by predicting the position of the subject and determining the display position (that is, the composition position) of the auxiliary image SP in accordance with a predicted location, it is possible to eliminate the strangeness on the display and provide the user with a good experience.

As described with reference to FIG. 1 and the like, the first captured image (for example, an image obtained on the basis of the exposure operation P1 in FIG. 7) and the second captured image (for example, an image obtained on the basis of the exposure operation R1 in FIG. 7) may be the preview image PP displayed on the display unit 17 (display unit 41).

Since the discrepancy between the display position of the subject and the display position of the auxiliary image SP such as the frame image displayed in association with the subject in the preview image PP is reduced, the user can perform an appropriate imaging operation while viewing the preview image PP. Therefore, the user can be provided with high-quality experience.

A program executed by the information processing device 1 (1A, 1B) as a calculation processing device according to the first embodiment includes a composition position determination function of determining the composition position of the auxiliary image SP in a second captured image (for example, an image obtained on the basis of the exposure operation R1 in FIG. 7) captured after a first captured image (for example, an image obtained on the basis of the exposure operation P1 in FIG. 7) in accordance with the position and motion of the subject (for example, a pupil of the person) in the first captured image, and a composition function of compositing the auxiliary image SP with the composition position in the second captured image.

As described in the second embodiment, the information processing devices 1A and 1B as smartphones each include a first processor (a calculation processing unit included in the camera control unit 30) that performs image processing on a captured image output from the pixel array unit 7 in which pixels having photoelectric conversion elements are two-dimensionally arranged and processing of determining the composition position of the auxiliary image SP to be composited with the captured image on the basis of the captured image, and a second processor (a calculation processing unit included in the control unit 3) that performs processing of displaying, on the display unit 41, a composite image obtained by compositing the auxiliary image SP with the composition position in the image on which the image processing has been performed.

For example, the first processor is a calculation processing unit that mainly performs processing related to imaging, and the second processor is a calculation processing unit that performs overall control of the information processing device and processing of implementing other applications.

By executing processing of identifying the position of a specific subject in the captured image, processing of determining the composition position of the auxiliary image SP, and the like by the first processor, it is possible to reduce the possibility that a usage rate of the processor increases due to an increase in a processing load of other applications and processing of determining the image processing and the composition position cannot be executed at a normal timing, and it is possible to prevent the frame image or the like superimposed on the subject from being excessively deviated.

As described with reference to FIG. 12 and the like, the first processor (the calculation processing unit included in the camera control unit 30) may perform the image processing and the processing of determining the composition position in parallel.

For example, the composition position can be determined earlier by performing the processing of determining the composition position on the captured image before performing the pre-processing such as brightness and white balance adjustment processing than by performing the processing of determining the composition position on the image after performing the pre-processing on the captured image.

In this case, it is possible to quickly end the processing of determining the composition position before ending the pre-processing. As a result, the auxiliary image SP can be composited with the preview image PP used for determining the composition position of the auxiliary image SP, and the auxiliary image SP can be prevented from being deviated from the subject.

As described above, the first processor (the calculation processing unit included in the camera control unit 30) may execute the processing of compositing the auxiliary image SP with the image subjected to the image processing (for example, the low-resolution preview image PP).

The processing load of the second processor (the calculation processing unit included in the control unit 3) can be reduced by the first processor performing processing up to a portion of compositing the auxiliary image SP with the preview image PP. Therefore, the processing of compositing the auxiliary images SP is prevented from being delayed, and the deviation of the auxiliary image SP from the subject can be prevented.

As described above, the auxiliary image SP in the second embodiment may be a frame image indicating a specific position of a subject (for example, a pupil of a person).

For example, in a case where the subject is a person, the auxiliary image SP is a face frame in face detection, a pupil frame in pupil detection, or the like.

As a result, the display position of the frame image as the auxiliary image SP can be prevented from deviating from the face or pupil of the subject. Therefore, the user can appropriately confirm a recognition result in the image processing.

As described with reference to FIG. 13 and the like, the frame image may be an image indicating the focus position.

For example, the auxiliary image SP is an in-focus frame indicating a focus region.

As a result, a display deviation between the focus region and the in-focus frame in the captured image is eliminated. Therefore, the user can release the shutter without missing an optimum imaging timing by appropriately confirming the focus region.

As described in the modification, the auxiliary image SP may be an image indicating the position of a specific subject (for example, a pupil of a person) recognized as a result of image recognition processing on the captured image.

For example, in a case where image recognition processing for detecting a vehicle in a captured image is executed, a frame image as the auxiliary image SP is composited and displayed so as to surround the vehicle.

Therefore, since the frame image and the like indicating a processing result of the image recognition can be superimposed on the subject to be recognized at an appropriate position, the user can appropriately confirm the result of the image recognition processing.

The information processing device 1A according to the second embodiment and the information processing device 1B according to the third embodiment may serve as smartphones including the pixel array unit 7.

In a relatively small terminal device including an imaging unit (the camera module 2) such as a smartphone, there is a high possibility that a position of a subject in a captured image and a display position of the auxiliary image SP such as a frame image displayed in association with the subject are not in an appropriate positional relationship and deviate due to hardware limitations such as low processing capability or inability to increase performance due to power restriction.

However, even in such a terminal device, with the configuration described above, by predicting the position of the subject and determining the display position (that is, the composition position) of the auxiliary image SP in accordance with a predicted location, it is possible to eliminate the strangeness on the display and provide the user with a good experience.

The program executed by the information processing devices 1A and 1B as the calculation processing devices according to the second and third embodiments causes the first processor (the calculation processing unit included in the camera control unit 30) to execute the image processing on a captured image output from the pixel array unit 7 and the processing of determining the composition position in the auxiliary image SP to be composited with the captured image on the basis of the captured image, and causes the second processor (the calculation processing unit included in the control unit 3) to execute the processing of displaying, on the display unit 41, a composite image obtained by compositing the auxiliary image SP with the composition position of the image subjected to the image processing.

Note that the effects described in the present specification are merely examples and are not limited, and other effects may be exerted.

Furthermore, each example described above may be composited in any way, and the above-described various functions and effects may be obtained even in a case where various combinations are used.

### 6. Present Technology

The present technology may also adopt the following configurations.

(1)

An information processing device including
a composition position determiner that determines a composition position of an auxiliary image in a second captured image captured after a first captured image in accordance with a position and a motion of a subject in the first captured image, and
a composition processing unit that composites the auxiliary image with the composition position in the second captured image.

(2)

The information processing device according to (1) described above, in which
the composition position determiner determines the position of the subject on the second captured image as the composition position on the basis of the position of the subject in the first captured image and a difference between imaging timings of the first captured image and the second captured image.

(3)

The information processing device according to (1) or (2) described above, in which
the motion of the subject is identified by using a captured image captured before the first captured image.

(4)

The information processing device according to any of (1) to (3) described above, in which
the auxiliary image is a frame image indicating a specific position of the subject.

(5)

The information processing device according to (4) described above, in which
the frame image is an image indicating a focus position.

(6)

The information processing device according to any of (1) to (3) described above, in which
the auxiliary image is an image indicating a position of a specific subject recognized as a result of image recognition processing on the first captured image.

(7)

The information processing device according to any of (1) to (6) described above, in which
the information processing device serves as a smartphone including an imaging unit that captures the first captured image and the second captured image.

(8)

The information processing device according to any of (1) to (7) described above, in which
the first captured image and the second captured image are preview images displayed on a display unit.

(9)

A program for
causing a calculation processing device to execute:
a composition position determination function of determining a composition position of an auxiliary image in a second captured image captured after a first captured image in accordance with a position and a motion of a subject in the first captured image; and
a composition function of compositing the auxiliary image with the composition position in the second captured image.

(10)

An information processing device including
a first processor that performs image processing on a captured image output from a pixel array unit in which pixels each having a photoelectric conversion element are two-dimensionally arranged and processing of determining a composition position of an auxiliary image to be composited with the captured image on the basis of the captured image, and
a second processor that performs processing of displaying, on a display unit, a composite image obtained by compositing the auxiliary image with the composition position in an image subjected to the image processing.

(11)

The information processing device according to (10) described above, in which
the first processor performs the image processing and the processing of determining the composition position in parallel.

(12)

The information processing device according to (10) or (11) described above, in which
the first processor executes processing of compositing the auxiliary image with the image subjected to the image processing.

(13)

The information processing device according to any of (10) to (12) described above, in which
the auxiliary image is a frame image indicating a specific position of a subject.

(14)

The information processing device according to (13) described above, in which
the frame image is an image indicating a focus position.

(15)

The information processing device according to any of (10) to (12) described above, in which
the auxiliary image is an image indicating a position of a specific subject recognized as a result of image recognition processing on the captured image.

(16)

The information processing device according to any of (10) to (15) described above, in which
the information processing device serves as a smartphone including the pixel array unit.

(17)

A program for
causing a first processor to execute image processing on a captured image output from a pixel array unit and processing of determining a composition position in an auxiliary image to be composited with the captured image on the basis of the captured image, and
causing a second processor to execute processing of displaying, on a display unit, a composite image obtained by compositing the auxiliary image with the composition position of an image subjected to the image processing.

### REFERENCE SIGNS LIST

1, 1A, 1B Information processing device
17 Display unit
25 Composition position determiner
26 Composition processing unit
41 Display unit
PP Preview image (image subjected to image processing)
SP Auxiliary image

1. An information processing device comprising:
a composition position determiner that determines a composition position of an auxiliary image in a second captured image captured after a first captured image in accordance with a position and a motion of a subject in the first captured image; and
a composition processing unit that composites the auxiliary image with the composition position in the second captured image.

2. The information processing device according to claim 1, wherein
the composition position determiner determines the position of the subject on the second captured image as the composition position on a basis of the position of the subject in the first captured image and a difference between imaging timings of the first captured image and the second captured image.

3. The information processing device according to claim 1, wherein
the motion of the subject is identified by using a captured image captured before the first captured image.

4. The information processing device according to claim 1, wherein
the auxiliary image is a frame image indicating a specific position of the subject.

5. The information processing device according to claim 4, wherein
the frame image is an image indicating a focus position.

6. The information processing device according to claim 1, wherein
the auxiliary image is an image indicating a position of a specific subject recognized as a result of image recognition processing on the first captured image.

7. The information processing device according to claim 1, wherein
the information processing device serves as a smartphone including an imaging unit that captures the first captured image and the second captured image.

8. The information processing device according to claim 1, wherein
the first captured image and the second captured image are preview images displayed on a display unit.

9. A program for
causing a calculation processing device to execute:
a composition position determination function of determining a composition position of an auxiliary image in a second captured image captured after a first captured image in accordance with a position and a motion of a subject in the first captured image; and
a composition function of compositing the auxiliary image with the composition position in the second captured image.

10. An information processing device comprising:
a first processor that performs image processing on a captured image output from a pixel array unit in which pixels each having a photoelectric conversion element are two-dimensionally arranged and processing of determining a composition position of an auxiliary image to be composited with the captured image on a basis of the captured image; and
a second processor that performs processing of displaying, on a display unit, a composite image obtained by compositing the auxiliary image with the composition position in an image subjected to the image processing.

11. The information processing device according to claim 10, wherein
the first processor performs the image processing and the processing of determining the composition position in parallel.

12. The information processing device according to claim 10, wherein
the first processor executes processing of compositing the auxiliary image with the image subjected to the image processing.

13. The information processing device according to claim 10, wherein
the auxiliary image is a frame image indicating a specific position of a subject.

14. The information processing device according to claim 13, wherein
the frame image is an image indicating a focus position.

15. The information processing device according to claim 10, wherein
the auxiliary image is an image indicating a position of a specific subject recognized as a result of image recognition processing on the captured image.

16. The information processing device according to claim 10, wherein
the information processing device serves as a smartphone including the pixel array unit.

17. A program for
causing a first processor to execute image processing on a captured image output from a pixel array unit and processing of determining a composition position in an auxiliary image to be composited with the captured image on a basis of the captured image, and
causing a second processor to execute processing of displaying, on a display unit, a composite image obtained by compositing the auxiliary image with the composition position of an image subjected to the image processing.
